(19) United States
(12) Patent Application Publication
(10) Pub. No.: US 2005/0002654 A1
(43) Pub. Date: Jan. 6, 2005

(54) Method for playing back optical videodisc

(76) Inventors: Chee-Wen Shiah, Shindian City (TW); Chun Jung Shih, Shindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/612,095

(22) Filed: Jul. 2, 2003

(51) Int. Cl. H04N 5/781

(52) U.S. Cl. 386/125; 386/126

(57) ABSTRACT

The present invention relates to a method for playing back optical videodisc by using an optical disc drive. The optical disc drive caches the video data to a storage device at its highest possible speed until the entire video data has been completely read and stored. The operation of the optical disc drive is then halted to achieve the highest usage efficiency of the optical disc drive. In the meanwhile, during the above-mentioned caching process, a video-playback device acquires the stored video data from the storage device according to the video playing speed and simultaneously outputting data to a video display unit for playing back the video. The goal of power saving is achieved with elimination of the redundant idling time of the optical disc drive. It also tremendously reduces the optical power degradation of the pick-up head in the optical disc drive and hence prolonging its life expectancy.

### BACKGROUND OF THE INVENTION

1. Field of the Invention

The present invention is a method for playing back optical videodisc, especially relates to a power saving method for playing back optical videodisc (e.g. VCD, DVD) on notebook computer using an optical disc drive.

2. Description of the Prior Art

Due to the powerful capabilities and conveniences brought along by notebook computers, it is thereby gradually replacing the desktop PC and becoming one of the basic mobile appliances for modern day people. However, the biggest drawback of the notebook computer is its limitation on battery power, which can only support up to a few hours of electrical supply and hence notebook computer is incapable of long-term usage. Generally, the motor of an optical disc drive is the most power consuming mechanism in a notebook computer. Although the present day optical disc drives (DVD player) and optical videodisc playback software (e.g. Power DVD software) are both displaying the video data in immediate play manner (i.e. the motor keeps running and the pickup head keeps lighting as playing back the video disc). However, video-playing speed does not change along with the continuously advancing in reading speed of optical disc drives. Therefore, in most of the time the optical disc drive is either at a state of idling or waiting to read. It does not only accelerate the optical power degradation of the pick-up head, but also tremendously waste notebook battery power. In this way, the notebook battery might be exhausted before the end of a two-hour video film.

### SUMMARY OF THE INVENTION

According to the problems mentioned in the above article, it is therefore a primary object of the present invention to provide a power saving method for playing back optical videodisc in order to reduce the power wastage of computer battery. The present invention completely utilizes the reading efficiency of an optical disc drive by firstly caching entire video data to a storage device in a computer and then gradually plays back it according to the video playing speed. Hence the power saving is achieved with elimination of the redundant idling time of the optical disc drive and furthermore, the optical power degradation of the pick-up head can also be greatly reduced.

The main technical characteristic of the present invention is to provide a power saving method for playing back optical videodisc by using an optical disc drive. The present invention an optical disc drive reads the video data within the optical videodisc at its highest possible speed and stores the data to a storage device. The optical disc drive must be halted after the caching process is completed for achieving its highest efficiency of operation. In the meanwhile, during the above-mentioned caching process, a video-playback device acquires the stored video data from the storage device in accordance to the video playing speed and simultaneously outputting data to a video display unit for playing back the video film. In this manner, the goal of power saving is achieved with elimination of the redundant idling time of the optical disc drive. Nevertheless, it also tremendously reduces the optical power degradation of the pick-up head in the optical disc drive and hence prolonging its life expectancy.

The invention can be more fully understood by reading the following detailed description of the preferred embodiment, with reference made to the accompanying drawings as follows:

### BRIEF DESCRIPTION OF THE DRAWINGS

FIG. 1: the schematic diagram for the playback apparatus of optical videodisc in present invention

FIG. 2: the flow chart diagram for the playing back method of optical videodisc in present invention

### DETAILED DESCRIPTION OF THE INVENTION

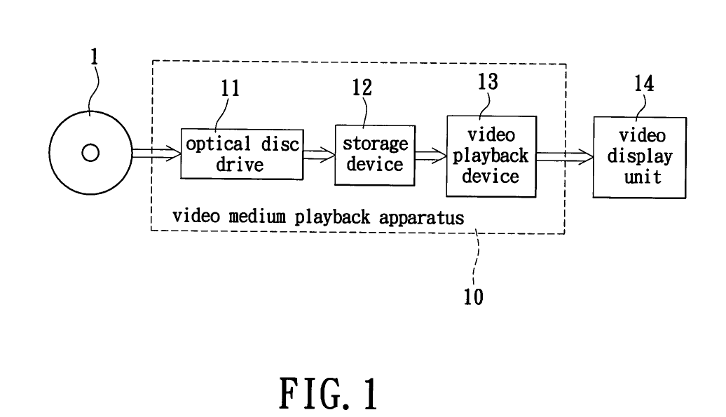

The present invention is the method for playing back optical videodisc, which is mainly applied to notebook computers for avoiding power wastage caused by idling of optical disc drive. However, this method can also apply to ordinary computer or video/audio medium play back apparatus (e.g. DVD drive machine). First, please refer to FIG. 1: the structural diagram for the playback apparatus of optical videodisc in the present invention. Wherein, the optical videodisc 1 can be a data carrier such as VCD, SVCD or DVD.

If the video medium playback apparatus 10 of the present invention is a general video/audio medium playback apparatus (e.g. DVD drive machine), then a storage device 12 must be added to cooperate with an existing optical disc drive 11 and video playback device 13. The optical disc drive, which is used to read video data from an optical videodisc 1, can be a drive of CD ROM, CD R/W, DVD ROM, DVD R/W or DVD RAM etc. The storage device 12 is connected to the optical disc drive 11 and is capable of storing data that is read by optical disc drive 11. A video-playback device 13 is connected to the storage device 12 and video display unit 14 in order to acquire video data stored within for outputting to a video display unit 14, which can be a television or an monitor set.

Due to the advancing of computer technologies the capacity of computer hard disk drive or memory is continuously expanding and becoming more cost-effective. In present days, the hard disk of a computer is easily over plural of ten Gigabyte and hence it can easily contain 4.7 Gbyte (in general) of DVD film without any difficulty. Therefore, the storage device 12 can be a hard disk, which consumes much less electrical power than an optical disc drive does.

The said storage device 12 can also be a random access memory (RAM) or a non-volatile memory. Presently, the RAM module has memory capacity as high up as one or two Gigabyte. Although it is still not enough for storing DVD films, however using a combination of plural memory modules can overcome this problem. Furthermore, the said combination of plural memory modules has even faster processing speed and lower power consumption advantages.

The method for playing back optical videodisc in the present invention can be applied to general computers or notebook computers. Wherein the video playback device 13 can be a video play back software and the video display device 14 can be a monitor.

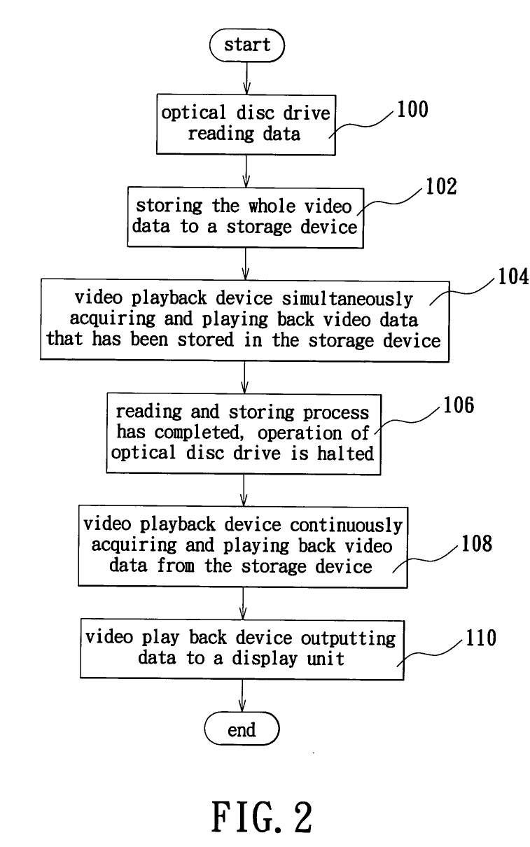

Please refer to FIG. 2: the flow chart diagram for the playing back method of optical videodisc in present invention. The playing back method in the present invention includes the following steps:
Step 100: the optical disc drive 11 reads video data from optical videodisc 1 at highest possible speed
Step 102: the optical disc drive 11 transfers and stores whole video data to a storage device 12
Step 104: In the mean while, the video play back device 13 simultaneously acquiring and playing back the video data that has been stored in the storage device 12, then outputting the data to the video display unit 14
Step 106: when the reading and storing process (cache) has completed, the operation of optical disc drive 11 is halted in order to avoid the unnecessary free running during idling time for power saving purpose
Step 108: in accordance to video playing speed, the video play back device 13 continuously acquiring and playing back video data from the storage device 12.
Step 110: video play back device 13 outputting the video data to the video display unit 14

At the present, in the case of 52× reading speed optical disc drive, only twenty minutes (20) is needed to complete reading a digital videodisc (DVD), but the playing back time can last out one hundred and twenty minutes (120) or even longer. Therefore, one can save about one hundred minutes (100) of electrical power wastage due to free running of drive during idling time. There is yet another advantage to the present invention. That is if one wish to continue watching after a video film had been stopped, or one wishes to watch it for the second time, there is no need for optical disc drive 11 to read the optical videodisc 1 over again since the video data will be acquired straight from the storage device 12. Consequently, more battery power will be saved using this method in the present invention.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intending to be embraced within the scope of the invention as defined in the appended claims.

1. A method for playing back optical videodisc by using an optical disc drive, the method comprising the following steps:
a. reading video a data from an optical videodisc at highest possible speed of the optical disc drive
b. storing the video data to a storage device
c. halting the operation of the optical disc after the reading process has completed in order to avoid the unnecessary free running during idling time for power saving purpose
d. according to a video playing speed, a video play back device continuously acquiring and playing back the video data from the storage device
e. outputting the video data to a video display unit

2. The method for playing back optical videodisc according to claim 1, wherein the said optical videodisc can be a VCD, SVCD or DVD.

3. The method for playing back optical videodisc according to claim 1, wherein the optical disc drive can be a CD ROM, DVD ROM, CD R/W, DVD R/W or DVD RAM.

4. The method for playing back optical videodisc according to claim 1, wherein the storage device in step (b) is a hard disc.

5. The method for playing back optical videodisc according to claim 1, wherein the storage device in step (b) is a random access memory (RAM).

6. The method for playing back optical videodisc according to claim 1, wherein the said storage device in step (b) is a non-volatile memory.

7. The method for playing back optical videodisc according to claim 1, wherein the step (b) further comprising the following sub-steps:
simultaneously acquiring and playing back the video data that has been stored in the storage device, then outputting the film data to a video display unit according to video playing speed.

8. The method for playing back optical videodisc according to claim 1, wherein the video display unit in step (e) is a television.

9. The method for playing back optical videodisc according to claim 1, wherein the video display unit in step (e) is a monitor.
